(19) United States
(12) Patent Application Publication
(10) Pub. No.: US 2014/0366304 A1
(43) Pub. Date: Dec. 18, 2014

(54) WIPER BLADE DEVICE

(71) Applicant: Robert Bosch GmbH, Stuttgart (DE)

(72) Inventor: Christian Wilms, Beringen-Koersel (BE)

(21) Appl. No.: 14/368,033

(22) PCT Filed: Dec. 13, 2012
(86) PCT No.: PCT/EP2012/075335

§ 371 Date: Jun. 23, 2014

(30) Foreign Application Priority Data
Dec. 27, 2011 (DE) 10 2011 089 928.6

(51) Int. Cl. B60S 1/38; B60S 1/40

(52) U.S. Cl. CPC B60S 1/3808; B60S 1/40
USPC 15/250.32

(57) ABSTRACT

The invention relates to a wiper device having at least one wiper unit (14a; 14b; 14c; 14d) arranged on a wiper arm (10a; 10b; 10c; 10d) and/or on a wiper blade (12a; 12b; 12c; 12d), the wiper unit comprising, in particular, a spoiler element (16a; 17a; 16b; 17b; 16c; 17c; 16d; 17d) and/or a wiper strip (18a; 18b; 18c; 18d) and/or a spring strip (20a; 20b; 20c; 20d). The wiper device comprises at least one adjustment unit (22a; 22b; 22c; 22d) for at least partially automatically adjusting at least one characteristic of the wiper unit (14a; 14b; 14c; 14d) depending on at least one parameter.

### BACKGROUND OF THE INVENTION

The invention relates to a wiper device.

A wiper device having a wiper unit is known from the prior art, the wiper unit being arranged on a wiper arm and/or a wiper blade and comprising, in particular, a spoiler element and/or a wiper strip and/or a spring strip.

### SUMMARY OF THE INVENTION

The invention relates to a wiper device having at least one wiper unit arranged on a wiper arm and/or on a wiper blade, the wiper unit comprising, in particular, a spoiler element and/or a wiper strip and/or a spring strip.

It is proposed that the wiper device comprises at least one adjustment unit which is provided to at least partially automatically adjust at least one characteristic of the wiper unit depending on at least one parameter, in particular simultaneously on a plurality of parameters. By the term “provided”, particularly specifically programmed and/or designed and/or equipped is to be understood here and below. The term “wiper unit” refers in this context particularly to a part of a wiper device, in particular a wiper blade device. The term “wiper strip” refers in this context particularly to a unit which comprises at least one wiper lip that, in at least one operation of the wiper device, is moved across a surface to be wiped, in particular a vehicle surface and preferably a vehicle window pane. In so doing, the wiper lip preferably contacts the vehicle surface during an entire movement thereof and is particularly advantageously pressed against the surface as uniformly as possible. The wiper strip is preferably embodied as one piece and preferably consists of a natural rubber and particularly advantageously of a synthetic rubber. The term “one piece” refers especially at least to a materially bonded connection, for example by means of a welding process, an adhesive bonding process, a molding process and/or another process that appears useful to the person skilled in the art, and/or refers advantageously to being formed in one piece as, for example, from a cast and/or by a manufacturing process using a single- or multi-component spraying method, and advantageously from a single blank. A “spoiler element” refers in this case to an element for deflecting a relative wind acting on the wiper device and/or for pressing the wiper strip against the surface to be wiped. The spoiler element preferably consists at least partially of rubber and/or of a plastic that is at least partially elastic. A “spring strip” refers in this context in particular to an element which has an extension that can be elastically changed in at least a normal operating state by at least 10%, in particular by at least 20%, preferably by at least 30% and particularly advantageously by at least 50% and which generates a counter force that is dependent on a change of the extension and counteracts said change. An “extension” of an element refers in this context particularly to a maximum distance between two points of a vertical projection of the element onto a plane. The spring strip preferably consists partially, preferably at least for the most part and particularly advantageously completely, of spring steel. By the spring strip consisting “at least for the most part” of spring steel, it is particularly to be understood that the spring strip consists of a mass portion of at least 50%, in particular of at least 70%, preferably of at least 90% and particularly advantageously of at least 95% spring steel. By the term “adjustment unit”, a unit is particularly to be understood in this context which, in at least one operating state, performs an active adjustment of the at least one characteristic of the wiper unit, in particular while taking into account the at least one parameter. The adjustment unit can particularly comprise a wind pressure surface which is moved in at least one operating state by oncoming air flow, this movement being used to adjust the characteristic of the wiper unit. The adjustment unit particularly comprises at least one actuator and preferably in addition a control unit which is particularly provided to receive at least one parameter characteristic variable and to control and/or regulate the actuator based on the parameter characteristic variable. By the term “parameter characteristic variable”, a variable characterizing the at least one parameter is to be understood in this context, in particular an electrical signal. The adjustment unit is preferably designed as a separate unit and, in particular, designed differently than a wiper arm drive unit for driving the entire wiper arm. By the adjustment unit being provided to “partially automatically adjust” the characteristic of the wiper unit, it is to be understood that the adjustment unit and particularly the actuator of the adjustment unit is provided to perform an active adjustment of the at least one characteristic, wherein particularly a manual intervention by an operator is also additionally possible, in particular electronically from a passenger cabin. The term “active adjustment” refers particularly to an adjustment of the at least one characteristic which is different from a purely passive characteristic change caused solely by ambient influences, in particular a characteristic change caused solely by ambient temperature and/or ambient moisture and/or an airflow velocity and/or an airflow pressure and/or of a contact pressure of a wiper blade. The term “airflow velocity” is to be particularly understood in this context as a velocity of an airflow relative to at least one point of the wiper device. “Airflow pressure” refers particularly to an area-related force which, in at least one operating state, acts on a unit, in particular the wiper unit, by said unit being subjected to an airflow. The “wiper blade contact force” refers particularly to an area-related force by means of which the wiper blade is pressed against the surface to be wiped in at least one operating state. By means of such an embodiment, a generic wiper device can be further developed in an advantageous manner. Furthermore, an advantageous adaptation of the wiper device to conditions existing in at least one operating state can take place, whereby in particular a wiping performance can be optimized. In addition, an accumulation of liquid can be advantageously reduced, in particular if a position of the wiper unit is changed, whereby particularly splashing of the surface to be wiped can be prevented.

In addition, it is proposed that the adjustment unit is provided to at least adjust a pitch and/or at least a mechanical preload and/or at least a flexibility and/or at least a position and/or at least a shape of the wiper unit. By the term “pitch” of the wiper unit, an angle between a normal or a main extension plane of the wiper unit and the direction of gravity is to be understood. A “main extension plane” of a unit refers particularly to a plane which of all planes has the largest number of points of intersection with the unit. In the event that a plurality of planes has the largest number of points of intersection, a plane which at least intersects the unit and has the smallest average distance to all of said planes, in particular to lines of intersection of any pairs of said planes, shall particularly be understood as the main extension plane. As a result, a particularly advantageous wiping performance can be achieved. A wiper blade contact pressure, an air resistance coefficient and/or an adaptation of the wiper blade to the surface to be wiped can especially be optimized. Furthermore, a rigidity of the spring strip and/or the wiper strip can be adapted to the weather conditions.

The adjustment unit is advantageously provided to adjust the characteristic as a function of at least a driving speed of a vehicle and/or at least an airflow velocity and/or at least an airflow pressure and/or at least a wiper blade contact pressure and/or at least a wiping angle and/or at least a wiper speed and/or at least a wiping frequency and/or at least an accruing amount of liquid and/or at least an ambient temperature. A “wiping angle” refers in this context especially to an angle between the wiper arm in the rest position thereof and the wiper arm in a deflected position. A “rest position” of the wiper arm refers here particularly to an unambiguously defined position in which the wiper arm rests in an inactive state. The term “wiper speed” is to be particularly understood as a value of a maximum angular speed of the wiper arm during at least one wiping action. “Wiping frequency” refers in this context particularly to the number of wiping actions per time interval. As a result, it can be ensured that important parameters are taken into account in at least one operating state.

In a preferred embodiment, it is proposed that the adjustment unit comprises at least one actuator unit. By the term “actuator unit”, a converter is especially to be understood which converts an energy supplied thereto, preferably an electrical energy, into a mechanical movement and/or into another physical quantity that is different from a pure heat energy, in particular into a liquid or gas pressure. The actuator unit can be designed as any actuator unit which appears useful to the person skilled in the art, in particular as an hydraulic and/or pneumatic unit and/or as a bimetallic actuator unit and/or as an electric motor, in particular a multiphase motor, and/or as an expansion material actuator unit and/or as a magnetostrictive actuator unit and/or as a shape memory actuator unit and/or preferably as a piezo actuator unit. An “hydraulic actuator unit” is particularly to be understood as an actuator unit which, in at least one operating state, uses a supplied energy, preferably an electrical energy, to increase a liquid pressure and in particular provides a liquid subjected to pressure for a conversion into mechanical work, in particular by means of an hydraulic cylinder. A “pneumatic actuator unit” particularly refers to an actuator unit which, in at least one operating state, uses a supplied energy, preferably an electrical energy, for an increase in a gas pressure and in particular provides a gas subjected to pressure for conversion into mechanical work, in particular by means of a pneumatic cylinder. A “bimetallic actuator unit” refers in this context especially to an actuator unit which, in at least one operating state, generates a mechanical movement by means of at least one bimetallic element. The bimetallic actuator unit particularly comprises at least one heating element for heating the bimetallic element. A “piezo actuator unit” is particularly to be understood as an actuator unit which, in at least one operating state, produces a mechanical movement through the use of the inverse piezoelectric effect. A magnetostrictive actuator unit refers here particularly to an actuator unit which, in at least one operating state, produces a mechanical movement through the use of the effect of magnetostriction. By the term “expansion material actuator unit”, an actuator unit is to be particularly understood in this context which, in at least one operating state, produces a mechanical movement by means of a phase transition of an expansion material, in particular an oil and/or a wax and/or a hard paraffin wax. The expansion material actuator unit particularly comprises at least one heating element for heating the expansion material. A “shape memory actuator unit” refers in this case particularly to an actuator unit which comprises at least one element made from a shape memory alloy in order to produce a mechanical movement. The shape memory actuator unit particularly comprises at least one heating element for heating the shape memory alloy. In so doing, an advantageous open-loop and/or closed-loop controllability of the at least one characteristic of the wiper unit can be achieved. In addition, already existing systems can be accessed.

In a particularly preferred embodiment, it is proposed that the wiper device comprises at least one pressure characteristic variable measuring unit which is provided to measure at least one area-related normal force characteristic variable. A “normal force characteristic variable” refers especially to a variable characteristic of a force acting perpendicularly to a surface. The pressure characteristic variable measuring unit can relate to any pressure characteristic variable measuring unit that appears useful to the person skilled in the art, in particular to a direct pressure measuring unit which directly measures a force acting on a test surface and preferably to a piezoresistive pressure measuring unit. As a result, an acquisition of particularly important parameters for a wiping operation can be facilitated. A control circuit can particularly be provided which adjusts an area-related normal force to an optimal value.

If the pressure characteristic variable measuring unit is provided to measure an airflow pressure characteristic variable, winds occurring in addition to a relative wind, in particular headwinds, can also be taken into account in an advantageously simple manner as a measure for a driving speed. A control circuit can furthermore be provided which adjusts the airflow pressure to an optimal value, in particular for the purpose of reducing an air resistance coefficient and ensuring a sufficiently high wiper blade contact pressure. An “airflow pressure characteristic variable” is to be particularly understood as a variable characteristic of an airflow pressure. The pressure characteristic variable measuring unit can be designed in this case particularly at least partially as one piece with a spoiler element and preferably be integrated in the spoiler element. In order to measure the airflow pressure, the spoiler element can particularly be at least substantially moved and/or deformed by the airflow pressure. The phrase “at least substantially moved and/or deformed” means in this context that the spoiler is moved and/or deformed by at least 0.25 mm, in particular by at least 0.5 mm, preferably by at least 0.75 mm and especially advantageously by at least 1 mm in one direction.

It is proposed in a further embodiment of the invention that the pressure characteristic variable measuring unit is provided to measure a wiper blade contact pressure characteristic variable. A variable characteristic of a wiper blade contact pressure is particularly to be understood by the term “wiper blade contact pressure characteristic variable”. In particular, the pressure characteristic variable measuring unit can particularly comprise at least a distance measuring device and measure a distance of a unit or an element from the surface to be wiped as the wiper blade contact pressure characteristic variable, wherein the wiper blade contact pressure can particularly be determined by means of a known elasticity constant and/or flexural rigidity of the wiper strip. In so doing, a control circuit can be provided which adjusts the wiper blade contact pressure to an optimal value. In particular, a maximum capacity of a wiper arm drive unit can be reduced because said drive unit no longer has to be designed for a potentially maximum wiper blade contact pressure that can occur. As a result, costs and installation space can be reduced. In addition, energy consumption can be reduced.

A method with a wiper device is furthermore proposed which device has at least one wiper unit arranged on a wiper arm and/or on a wiper blade, said wiper unit particularly comprising a spoiler element and/or a wiper strip and/or a spring strip. In the proposed method, a characteristic of the wiper unit is at least partially automatically adjusted as a function of at least one parameter. As a result, a wiper device can be further developed in an advantageous manner.

### BRIEF DESCRIPTION OF THE DRAWINGS

Further advantages ensue from the following description of the drawings. Four exemplary embodiments of the invention are depicted in the drawings. The drawings, the description and the claims contain numerous features in combination. The person skilled in the art can also expediently consider the features individually and put them together to form further useful combinations.

In the drawings:

FIG. 1 shows a wiper arm and a wiper blade comprising a wiper device which includes a wiper unit having two spoiler elements, an adjustment unit and a pressure characteristic variable measuring unit for measuring an airflow pressure in a top view;

FIG. 2 shows a portion of the wiper blade from FIG. 1 in a cross-sectional view along a line II-II in FIG. 1;

FIG. 3 shows a portion of a further wiper blade comprising an alternative wiper device in a cross-sectional view;

FIG. 4 shows a wiper arm and a further wiper blade having an alternative wiper device which comprises a wiper unit having two spoiler elements, an adjustment unit having six actuator units and four pressure characteristic variable measuring units for measuring an airflow pressure in a top view;

FIG. 5 shows a portion of the wiper blade from FIG. 4 in a cross-sectional view along a line V-V in FIG. 4;

FIG. 6 shows a wiper arm and a wiper blade comprising a further wiper device which includes a wiper unit having a wiper strip and an adjustment unit in a top view; and

FIG. 7 shows a portion of the wiper blade from FIG. 6 in a cross-sectional view along a line VII-VII in FIG. 6.

### DETAILED DESCRIPTION

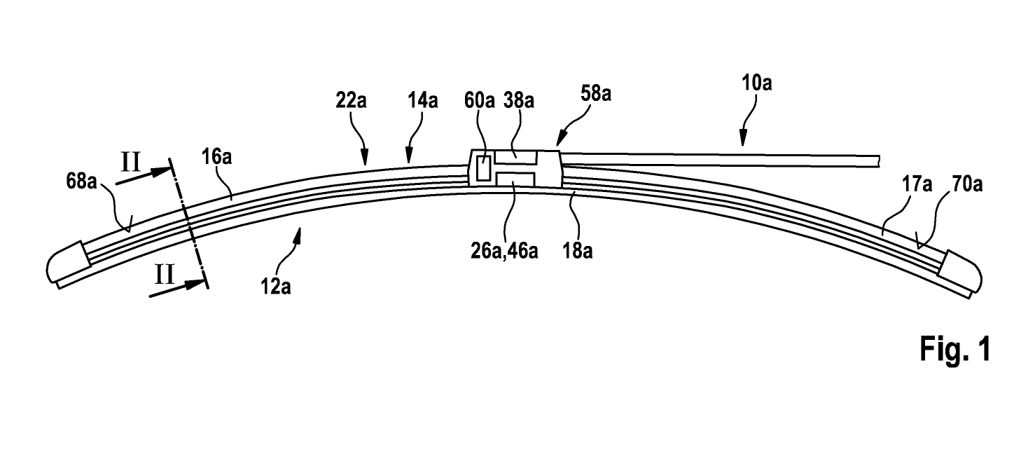

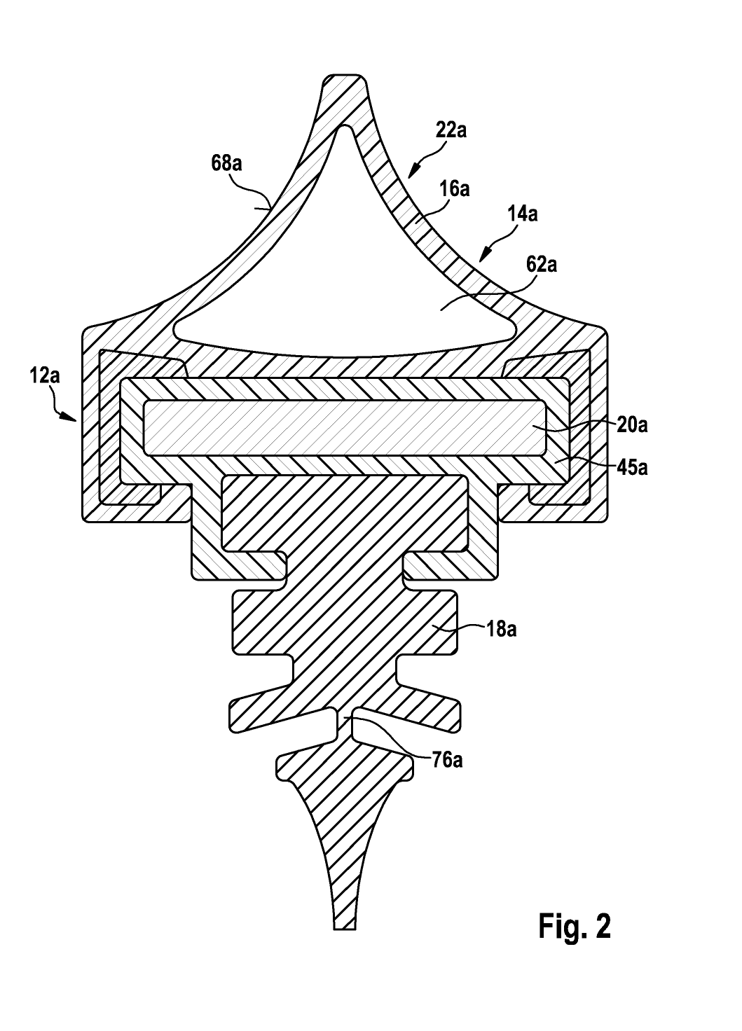

FIG. 1 shows a windshield wiper comprising a wiper arm 10a and a wiper blade 12a in a top view. The wiper blade 12a comprises a spring strip 20a, a wiper strip 18a and a retaining element 45a (cf. FIG. 2). The wiper blade 12a further comprises a wiper device having a wiper unit 14a. The wiper unit 14a is arranged on the wiper blade 12a. The wiper unit 14a includes two spoiler elements 16a, 17a. The wiper device further comprises an adjustment unit 22a which is provided to at least partially automatically adjust at least one characteristic of the wiper unit 14a as a function of at least one parameter. The adjustment unit 22a comprises a controlling element 46a designed as an actuator unit 26a. The actuator unit 26a is disposed within a wiper blade adapter 58a of the wiper blade 12a. The adjustment unit 22a further comprises a control unit 60a which is provided to control the actuator unit 26a. In one operating state, the control unit 60a correspondingly reads an electronic measurement signal of a pressure characteristic variable measuring unit 38a of the wiper device. The pressure characteristic variable measuring unit 38a is arranged in the wiper blade adapter 58a. The pressure characteristic variable measuring device 38a is provided to measure an area-related normal force. The area-related normal force relates to an airflow pressure. The control unit 60a thus carries out a method in one operating state, in which method a characteristic of the wiper unit 14a is at least partially automatically adjusted depending on at least one parameter. The actuator unit 26a, the pressure characteristic variable measuring unit 38a and the control unit 60a are supplied with electrical energy via cables installed along the wiper arm 10a (not shown in the drawings for the sake of clarity). An inductive energy supply is also alternatively or additionally conceivable.

FIG. 2 shows a portion of the wiper blade 12a in a cross-sectional view along a line II-II in FIG. 1. The spoiler elements 16a, 17a of the wiper unit 14a are designed in each case as one piece. The spoiler elements 16a, 17a are each made from a material that is at least partially elastic, in particular from a plastic material and preferably from rubber. The spoiler elements 16a, 17a comprise respectively a closed hydraulic channel 62a. In an installed state, the hydraulic channels 62a accommodate in each case a hydraulic fluid. The actuator unit 26a comprises a fluid compressor which is connected via at least one hydraulic line to the hydraulic channels 62a (not depicted in the drawings for the sake of clarity). In one operating state, the actuator unit 26a is provided to adjust a fluid pressure of the hydraulic fluid. Due to the elasticity of the spoiler elements 16a, 17a, an external shape and/or a pitch of the spoiler elements 16a, 17a of the wiper unit 14a can be adjusted. As an alternative, an actuator unit comprising a gas compressor can also be used instead of the actuator unit comprising the fluid compressor. In this case, spoiler elements comprise in each case a closed pneumatic channel and the gas compressor is connected to the pneumatic channels via at least one pneumatic line. In addition, it is further conceivable that spoiler elements are each equipped with two or more hydraulic and/or pneumatic channels. An adjustment of the external shape and/or the pitch of the wiper unit 14a is performed by the adjustment unit 22a while taking into account the airflow pressure determined by the pressure characteristic variable measuring unit 38a. To this end, the control unit 60a evaluates the measurement signal of the pressure characteristic variable measuring unit 38a and correspondingly controls and/or regulates the actuator unit 26a. Thus, the characteristics of the wiper unit 14a can be adjusted particularly in real time such that a wiper blade contact pressure on a surface to be wiped is maintained in an optimal range. Besides the airflow pressure, a driving speed of a vehicle comprising the windshield wipers and/or an airflow velocity and/or a wiper blade contact pressure and/or a wiping angle and/or a wiper speed and/or a wiping frequency and/or an accruing volume of liquid measured by a rain sensor and/or an ambient temperature can additionally or alternatively be taken into account as a parameter and processed by a control unit.

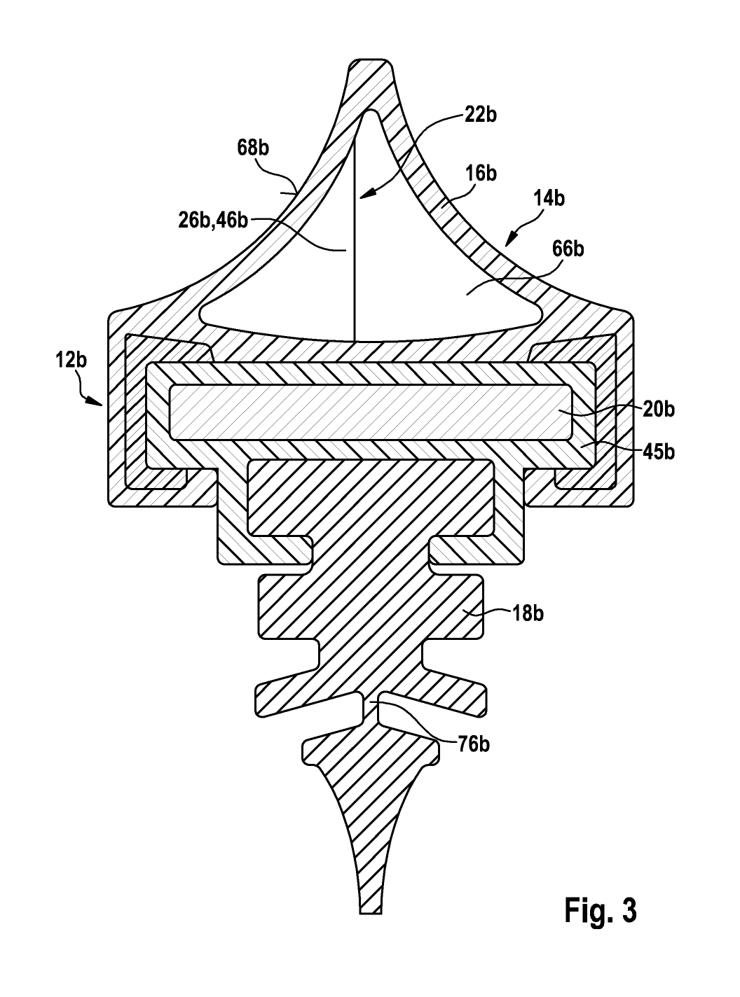

In FIGS. 3 to 7, three further exemplary embodiments of the invention are depicted. The following descriptions are limited substantially to the differences between the exemplary embodiments, wherein the description of the other exemplary embodiments, in particular FIGS. 1 and 2, can be referred to with regard to uniform components, features and functions. In order to differentiate between the exemplary embodiments, the letter a in the reference signs of the exemplary embodiment in FIGS. 1 and 2 is replaced by the letters b, c and d in the reference signs of the exemplary embodiments of FIGS. 3 to 7. With regard to identically referenced components, in particular with regard to components having the same reference signs, reference can basically be made to the figures and/or the description of the other exemplary embodiments, in particular to FIGS. 1 and 2.

FIG. 3 shows a portion of an alternative wiper blade 12b in a cross-sectional depiction. The wiper blade 12b comprises a wiper device including a wiper unit 14b and an adjustment unit 22b. The wiper unit 14b has two spoiler elements 16b, 17b. The spoiler elements 16b, 17b are formed in each case from an at least partially elastic material, in particular from a plastic material and preferably from rubber. The spoiler elements 16b, 17b have in each case an installation channel 66b. The adjustment unit 22b comprises an actuator unit 26b which is disposed in the installation channel 66b of the spoiler element 16b (only schematically depicted in FIG. 3), The adjustment unit 22b further comprises at least one further actuator unit which is disposed in the installation channel of the spoiler element 17b (not depicted). The actuator unit 26b is provided to adapt an external shape of the spoiler element 16b, in particular a steepness of a flank 68b of the spoiler element 16b, while taking into account a driving speed of a motor vehicle comprising the wiper blade 12b. The same applies to the further actuator unit disposed in the spoiler element 17b and in particular to a flank 70b of the spoiler element 17b. In addition, the adjustment unit 22b can comprise even further actuator units which can particularly be uniformly arranged along the installation channels 66b of the spoiler elements 16b, 17b. The actuator units 26b can relate to any actuator units 26b that appear useful to the person skilled in the art. In the present case, the actuator units 26b comprise in each case a multiphase motor. The wiper device comprises a control unit 60b which, in one operating state, reads a measurement signal of a tachometer unit of the motor vehicle (not depicted in FIG. 3). The control unit 60b is disposed in a wiper blade adapter 58b of the wiper blade 12b. A control unit can also alternatively be disposed in one of the installation channels 60b of the spoiler elements 16b, 17b or on the motor vehicle itself, in particular at least partially in a wiper arm drive unit. Signal lines as well as electrical supply lines are installed in the installation channels 60b of the spoiler elements 16b, 17b (not depicted for the sake of clarity). The control unit 60b controls and/or regulates the actuator units 26b as a function of a driving speed of the motor vehicle. It has particularly been proven to be useful to set the flanks 68b, 70b of the spoiler elements 16b, 17b to a flatter angle at low driving speeds and to a steeper angle at high driving speeds. Besides the driving speed of the motor vehicle, an airflow pressure and/or an airflow velocity and/or a wiper blade contact pressure and/or a wiping angle and/or a wiper speed and/or a wiping frequency and/or an accruing volume of liquid measured by means of a rain sensor and/or an ambient temperature can alternatively or additionally be taken into account as a parameter and be processed by a control unit.

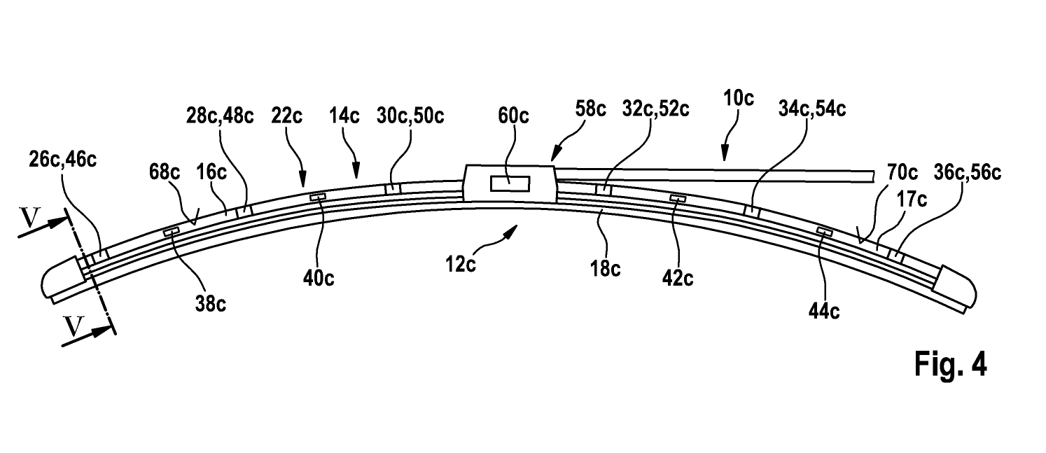

FIG. 4 shows a further windshield wiper comprising a wiper arm 10c and a wiper blade 12c in a top view. The wiper blade 12c comprises a wiper device having a wiper unit 14c. The wiper unit 14c comprises two spoiler elements 16c, 17c. The wiper device further comprises an adjustment unit 22c which is provided to at least partially automatically adjust at least one characteristic of the wiper unit 14c depending on at least one parameter. The adjustment unit 22c comprises six controlling elements 46c, 48c, 50c, 52c, 54c, 56c designed as actuator units 26c, 28c, 30c, 32c, 34c, 36c. The adjustment unit 22c further comprises a control unit 60c which is provided to control the actuator units 26c, 28c, 30c, 32c, 34c, 36c. The control unit 60c is disposed in a wiper blade adapter 58c of the wiper blade 12c. In one operating state, the control unit 60c reads electronic measurement signals of pressure characteristic variable units 38c, 40c, 42c, 44c of the wiper device. The pressure characteristic variable units 38c, 40c, 42c, 44c are provided in each case to measure an airflow pressure.

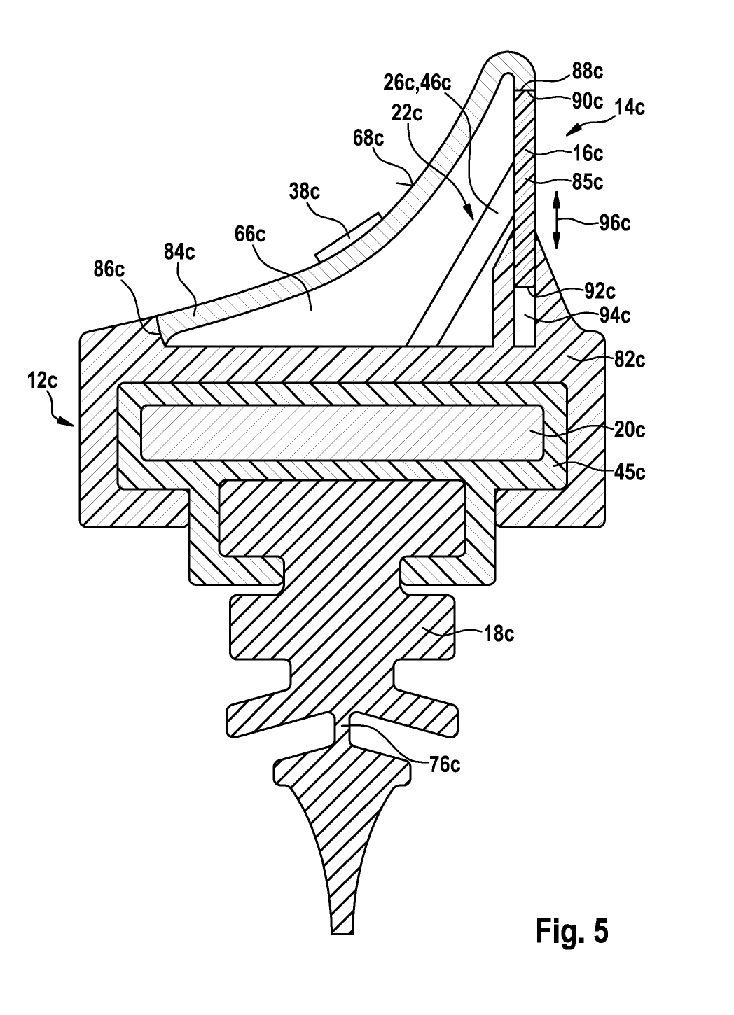

FIG. 5 shows a portion of the wiper blade 12c in a cross-sectional view along a line V-V in FIG. 4. The spoiler elements 16c, 17c have respectively an asymmetrical cross section. The spoiler elements 16c, 17c comprise in each case a base body 82c, a wind deflector 84c and a slide body 85c. The base body 82c, the wind deflector 84c and the slide body 85c of the spoiler elements 16c, 17c are formed as one piece. The spoiler elements 16c, 17c are manufactured in each case in a two component injection molding process. The base body 82c and the slide body 85c consist respectively of a material having a lower elasticity than the wind deflector 84c. The base body 82c is in each case fixedly fastened, in particular by engaging behind, to a retaining element 45c of the wiper blade 12c that clasps around a spring strip 20c. The wind deflector 84c is connected in each case on a first longitudinal side thereof to the base body 82c in a materially bonded manner. A second longitudinal side 88c of the wind deflector 84c is connected in each case in a materially bonded manner to a first longitudinal side 90c of the slide body 85c. In an installed state, a second longitudinal side 92c of the slide body 85c is placed in each case at least partially into a special receptacle 94c of the base body 82c. The receptacle 94c is in each case precisely matched to the second longitudinal side 92c of the slide body 85c. The second longitudinal side 92c of the slide body 85c is disposed in each case in a movable manner in the receptacle 94c along a direction 96c. The spoiler elements 16c, 17c form respectively an installation channel 66c. The actuator units 26c, 28c, 30c, 32c, 34c, 36c are disposed in the installation channels 66c of the spoiler elements 16c, 17c. In addition, the current supply lines and/or signal lines are installed in the installation channels 66c (not depicted in the drawings for the sake of clarity). The actuator units 26c, 28c, 30c, 32c, 34c, 36c, of which only one is visible and purely schematically depicted in FIG. 5, are provided to define an insertion depth of the slide body 85c in the receptacle 94c. The actuator units 26c, 28c, 30c, 32c, 34c, 36c can relate to any actuator units 26c, 28c, 30c, 32c, 34c, 36c that are considered useful by the person skilled in the art. In the present case, the actuator units 26c, 28c, 30c, 32c, 34c, 36c comprise respectively a multi-phase motor. The pressure characteristic variable measuring units 38c, 40c, 42c, 44c, of which only one is visible and is purely schematically depicted in FIG. 5, are disposed on the flanks 68c, 70c of the spoiler elements 16c, 17c which flanks are formed by the wind deflectors 84c, in particular are connected in a materially bonded manner to the same. In one operating state, the control unit 60c evaluates the measurement signals of the pressure characteristic variable measuring units 38c, 40c, 42c, 44c and controls and/or regulates the actuator units 26c, 28c, 30c, 32c, 34c, 36c in such a way that the airflow pressure in a respective range of the pressure characteristic variable measuring units 38c, 40c, 42c, 44c lies in an optimal range. In this regard, it is particularly conceivable that the actuator units 28c, 30c, 32c, 34c, 36c are actuated independently of one another by the control unit 60c. Hence, the characteristics of the wiper unit 14c can be adjusted in particular in real time such that a wiper blade contact pressure on a surface to be wiped is maintained in an optimal range. Besides the airflow pressure, a driving speed of a vehicle comprising the windshield wipers and/or an airflow velocity and/or a wiper blade contact pressure and/or a wiping angle and/or a wiper speed and/or a wiping frequency and/or an accruing volume of liquid measured by a rain sensor and/or an ambient temperature can alternatively or additionally be taken into account as a parameter and processed by a control unit.

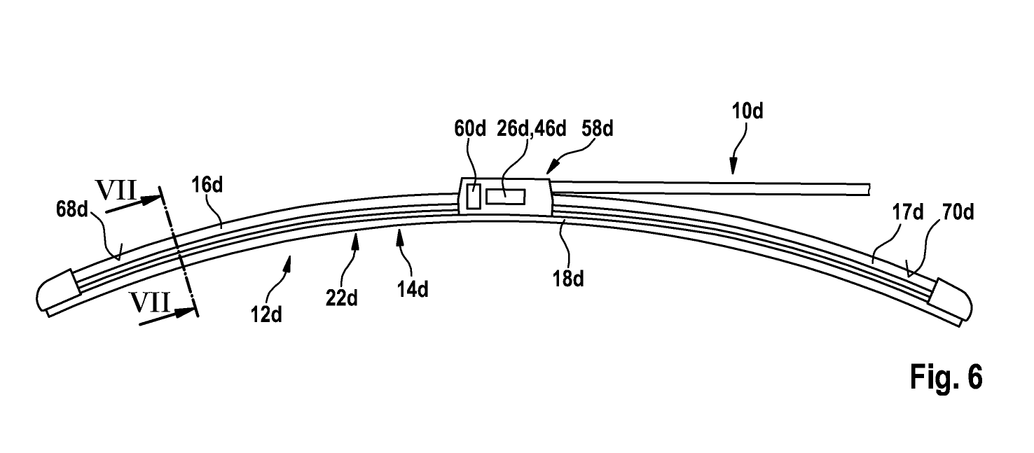

FIG. 6 shows a further windshield wiper comprising a wiper arm 10d and a wiper blade 12d in a top view. The wiper blade 12d comprises a wiper device having a wiper unit 14d. The wiper unit 14d includes a wiper strip 18d. The wiper device further comprises an adjustment unit 22d which is provided to at least partially automatically adjust at least one characteristic of the wiper unit 14d depending on at least one parameter. The adjustment unit 22d comprises a controlling element 46c designed as an actuator unit 26d. The actuator unit 26d is disposed within a wiper blade adapter 58d of the wiper blade 12d. The adjustment unit 22d further comprises a control unit 60d which is provided to control the actuator unit 26d. The control unit 60d is disposed in the wiper blade adapter 58d of the wiper blade 12d.

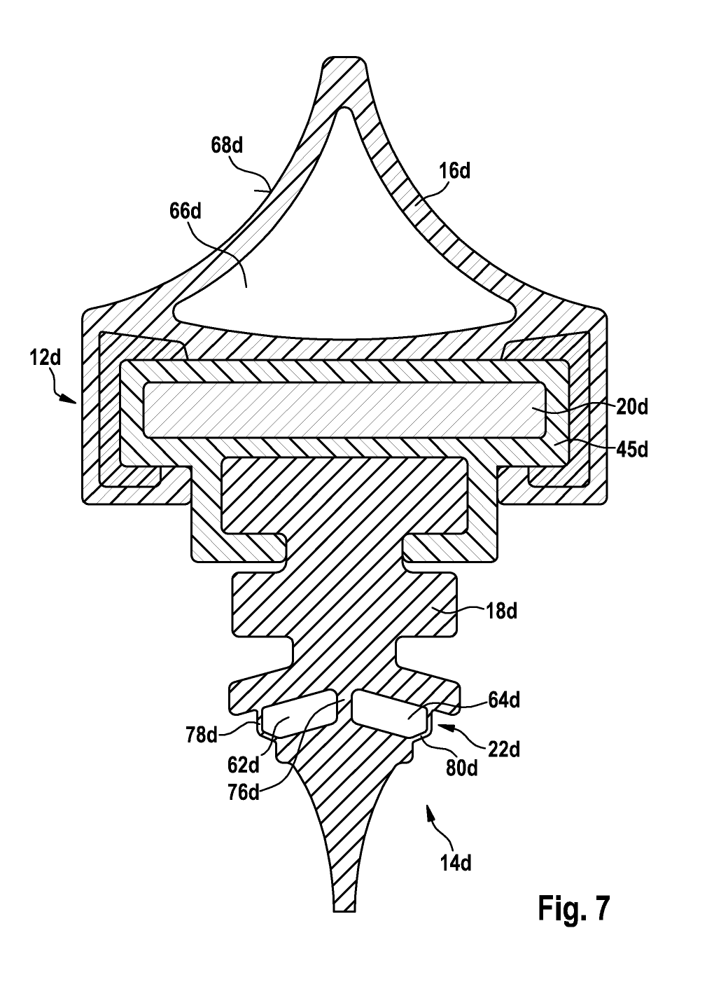

FIG. 7 shows a portion of the wiper blade 12d in a cross-sectional view along a line VII-VII in FIG. 6. The wiper strip 18d of the wiper unit 14d is designed as one piece. The wiper strip 18d consists of an at least partially elastic material, in particular of a synthetic rubber. Along a tilting web 76d of the wiper strip 18d, a closed hydraulic channel 62d, 64d is formed respectively on both sides of the tilting web 76d. External walls 78d, 80d of the hydraulic channels 62d, which walls face away from the tilting web 76d, are designed relatively thin, in particular thinner than the tilting web 76d. In an installed state, the hydraulic channels 62d, 64d accommodate a hydraulic fluid. The actuator unit 26d comprises a fluid compressor which is connected via at least one hydraulic line to the hydraulic channels 62d, 64d (not depicted in the drawings for the sake of clarity). In one operating state, the actuator unit 26d is provided for adjusting a fluid pressure of the hydraulic fluid. A flexibility of the wiper strip 18d of the wiper unit 14d can be adjusted via the fluid pressure. As an alternative, an actuator unit having a gas compressor can be used instead of the actuator unit 26d having the fluid compressor. In this case, the spring strip has two closed pneumatic channels and the gas compressor is connected via at least one pneumatic line to the pneumatic channels. An adjustment of this characteristic of the wiper unit 14d is performed by the adjustment unit 22d while taking at least one parameter into account. A driving speed of a motor vehicle comprising the windshield wiper and/or the wiper blade contact pressure and/or an airflow velocity and/or an airflow pressure and/or a wiping angle and/or a wiper speed and/or a wiping frequency and/or an accruing volume of liquid measured by means of a rain sensor and/or an ambient temperature are worth considering in this case as a parameter or parameters. The control unit 60d controls and/or regulates the actuator unit 26d accordingly, wherein said control unit 60d reads measurement signals which are characteristic for the at least one parameter from a corresponding measuring unit.

1. A wiper device having at least one wiper unit (14a; 14b; 14c; 14d) arranged on at least one of a wiper arm (10a; 10b; 10c; 10d) and a wiper blade (12a; 12b; 12c; 12d), and at least one adjustment unit (22a; 22b; 22c; 22d) for at least partially automatically adjusting at least one characteristic of the wiper unit (14a; 14b; 14c; 14d) depending on at least one parameter.

2. The wiper device according to claim 1, characterized in that the adjustment unit (22a; 22b; 22c; 22d) adjusts at least one of a pitch, a mechanical preload, a flexibility, a position and a shape of the wiper unit (14a; 14b; 14c; 14d).

3. The wiper device according to claim 1, characterized in that the adjustment unit (22a; 22b; 22c; 22d) adjusts the characteristic depending on at least one of a driving speed of a motor vehicle, an airflow velocity, an airflow pressure, a wiper blade contact pressure, a wiping angle, a wiper speed, a wiping frequency, an accruing volume of liquid and an ambient temperature.

4. The wiper device according to claim 1, characterized in that the adjustment unit (22a; 22b; 22c; 22d) comprises at least one actuator unit (26a; 26b; 26c, 28c, 30c, 32c, 34c, 36c; 26d).

5. The wiper device according to claim 1, characterized by at least one pressure characteristic variable measuring unit (38a; 38b; 38c, 40c, 42c, 44c; 38d, 40d, 42d) for measuring at least one area-related normal force characteristic variable.

6. The wiper device according to claim 5, characterized in that the pressure characteristic variable measuring unit (38a; 38b; 38c, 40c, 42c, 44c) is provided to measure an airflow pressure characteristic variable.

7. The wiper device according to claim 5, characterized in that the pressure characteristic variable measuring unit (38d, 40d, 42d) is provided to measure a wiper blade contact pressure characteristic variable.

8. A method for adjusting a wiper device having at least one wiper unit (14a; 14b; 14c; 14d) arranged on at least one of a wiper arm (10a; 10b; 10c; 10d) and a wiper blade (12a; 12b; 12c; 12d), the method comprising at least partially automatically adjusting a characteristic of the wiper unit (14a; 14b; 14c; 14d) depending on at least one parameter.

9. The adjustment unit (22a; 22b; 22c; 22d) of a wiper device according to claim 1.

10. A wiper arm (10a; 10b; 10c; 10d) comprising a wiper device according to claim 1.

11. A wiper blade (12a; 12b; 12c; 12d) comprising a wiper device according to claim 1.

12. The wiper device according to claim 1, characterized in that the adjustment unit (22a; 22b; 22c; 22d) adjusts a pitch of the wiper unit (14a; 14b; 14c; 14d).

14. The wiper device according to claim 1, characterized in that the adjustment unit (22a; 22b; 22c; 22d) adjusts a mechanical preload of the wiper unit (14a; 14b; 14c; 14d).

15. The wiper device according to claim 1, characterized in that the adjustment unit (22a; 22b; 22c; 22d) adjusts a flexibility of the wiper unit (14a; 14b; 14c; 14d).

16. The wiper device according to claim 1, characterized in that the adjustment unit (22a; 22b; 22c; 22d) adjusts a position of the wiper unit (14a; 14b; 14c; 14d).

17. The wiper device according to claim 1, characterized in that the adjustment unit (22a; 22b; 22c; 22d) adjusts a shape of the wiper unit (14a; 14b; 14c; 14d).

18. The wiper device according to claim 1, characterized in that the adjustment unit (22a; 22b; 22c; 22d) adjusts the characteristic depending on a driving speed of a motor vehicle.

19. The wiper device according to claim 1, characterized in that the adjustment unit (22a; 22b; 22c; 22d) adjusts the characteristic depending on an airflow velocity.

20. The wiper device according to claim 1, characterized in that the adjustment unit (22a; 22b; 22c; 22d) adjusts the characteristic depending on an airflow pressure.

21. The wiper device according to claim 1, characterized in that the adjustment unit (22a; 22b; 22c; 22d) adjusts the characteristic depending on a wiper blade contact pressure.

22. The wiper device according to claim 1, characterized in that the adjustment unit (22a; 22b; 22c; 22d) adjusts the characteristic depending on a wiping angle.

23. The wiper device according to claim 1, characterized in that the adjustment unit (22a; 22b; 22c; 22d) adjusts the characteristic depending on a wiper speed.

24. The wiper device according to claim 1, characterized in that the adjustment unit (22a; 22b; 22c; 22d) adjusts the characteristic depending on a wiping frequency.

25. The wiper device according to claim 1, characterized in that the adjustment unit (22a; 22b; 22c; 22d) adjusts the characteristic depending on an accruing volume of liquid.

26. The wiper device according to claim 1, characterized in that the adjustment unit (22a; 22b; 22c; 22d) adjusts the characteristic depending on an ambient temperature.

27. The wiper device of claim 1, wherein the wiper unit includes at least one of a spoiler element (16a, 17a; 16b, 17b; 16c, 17c; 16d, 17d), a wiper strip (18a; 18b; 18c; 18d) and a spring strip (20a; 20b; 20c; 20d).

28. A wiper device having at least one wiper unit arranged on a wiper arm and on a wiper blade, the wiper unit comprising a spoiler element, a wiper strip and a spring strip, and the wiper device having an adjustment unit for at least partially automatically adjusting at least one characteristic of the wiper unit depending on at least one parameter.

29. The wiper device according to claim 28, wherein the adjustment unit adjusts at least one of a pitch, a mechanical preload, a flexibility, a position and a shape of the wiper unit.

30. The wiper device according to claim 29, wherein the adjustment unit adjusts the characteristic depending on at least one of a driving speed of a motor vehicle, an airflow velocity, an airflow pressure, a wiper blade contact pressure, a wiping angle, a wiper speed, a wiping frequency, an accruing volume of liquid and an ambient temperature.
